(19) United States
(12) Patent Application Publication
(10) Pub. No.: US 2005/0157187 A1
(43) Pub. Date: Jul. 21, 2005

(54) Digital image-capturing device for use with removable memory device

(75) Inventor: Xie Bin, Dong-Guan City (CN)

Correspondence Address: TROXELL LAW OFFICE PLLC, SUITE 1404, 5205 LEESBURG PIKE, FALLS CHURCH, VA, 22041, US

(73) Assignee: Asia Optical Co., Inc.

(21) Appl. No.: 10/892,140

(22) Filed: Jul. 16, 2004

(30) Foreign Application Priority Data
Jan. 20, 2004 (TW) 093101526

(51) Int. Cl. H04N 5/76; G03B 17/24

(52) U.S. Cl. 348/231.7; 396/321; 348/231.2

(57) ABSTRACT

A digital camera for use in conjunction with a removable memory device is provided. The removable memory device includes a memory for storing digital images and a first electrical connector for transmitting the digital images to and from the memory. The digital camera includes a lens for inputting light, a photosensor for sensing the inputted light from the lens, an image-generated module for producing digital images based on the sensed by the photosensor, a second electrical connector separately connected with the first electrical connector of the removable memory device, and a user interface operable to allow a user to select and to access the produced digital images stored in the memory of the removable memory device through the first and second electrical connectors.

### BACKGROUND OF INVENTION

1. Field of the Invention

The present invention relates to an image-capturing device, and more specifically, to an image-capturing device used in conjunction with a plurality of removable storage devices, the removable storage devices each used to store digital images.

2. Description of the Prior Art

With the advent of digital camera, users can take pictures to be stored in digital format.

Please refer to FIG. 1 and FIG. 2. FIG. 1 is a diagram of a digital camera 10 according to the prior art. FIG. 2 is a functional block diagram of the digital camera 10 shown in FIG. 1. The camera 10 comprises a lens 12 for inputting light, a photosensor 14 for sensing the inputted light, an image-generated module 18 for generating an image based on the sensed light. The digital camera 10 contains a memory 16 such as a flash memory for storing digital images. The digital camera 10 contains an external connector 22 such as a male USB connector for allowing the digital camera 10 to connect to a host device such as a computer. The digital camera 10 connects to the host device for transferring digital images from the computer to the digital camera 10, and vice versa. The digital camera 10 contains a display 20 for indicating an operating state of the digital camera 10 to a user, such as showing the stored digital images along with information about battery life of the digital camera 10.

The digital camera 10 is popular for its small size. However, the digital camera 10 only has a fixed amount of memory 16 available for storing digital image. As an example, suppose that the memory 16 has a capacity of 64 MB, which can store about tens of digital images. If the owner of the digital camera 10 wishes to go on a long trip, it's the problem to take many images due to the small capacity of the memory 16. In addition, if the user wishes to replace the digital images with new digital images in the digital camera 10, the user must connect the digital camera 10 to the host device for downloading the taken images stored in the memory 16 of the digital camera 10 to the host. In order to overcome the problem, the long-trip user must buy multiple portable memory cards to store the captured images. U.S. Pat. No. 6,208,380 B1 discloses a memory card easily detachable to the digital camera, and U.S. Pat. No. 6,515,679 discloses a digital camera capable of copying images to a memory card in a copying mode. No matter using an easily detachable memory to a digital camera or providing a convenient user interface to transfer images from the digital camera to a memory card, the memory card must insert into a reader connected to a host for transferring the captured images to the host. It is very inconvenient for a user who loses or not carry the reader.

### SUMMARY OF INVENTION

It is therefore a primary objective of the claimed invention to provide a digital camera that can be connected to a removable memory device. The removable memory device can be connected to a host.

According to the claimed invention, a digital camera for being used in conjunction with a removable memory device is provided. The removable memory device includes a memory for storing digital images and a first electrical connector for transmitting the digital images to and from the memory. The digital camera includes a lens for inputting light, a photosensor for sensing the inputted light from the lens, an image-generated module for producing digital images based on the sensed by the photosensor, a second electrical connector separately connected with the first electrical connector of the removable memory device, and a user interface operable to allow a user to select and to access the produced digital images stored in the memory of the removable memory device through the first and second electrical connectors.

According to the claimed invention, a digital camera for be used in conjunction with a universal serial bus (USB) portable storage device is provided. The USB portable storage device comprises a memory for storing digital images and a first USB connector for transmitting the digital images to and from the memory. The digital camera comprises a lens for inputting light, a photosensor for sensing the inputted light from the lens, an image-generated module for producing digital images based on the sensed by the photosensor, a second USB connector separately connected with the first USB connector of the USB portable storage device, and a user interface operable to allow a user to select and to access the digital images stored in the memory of the USB portable storage device through the first and second USB connectors.

The advantage of this invention is that the image-capture apparatus can connect to multiple removable memory device so as to avoid the problem of the memory capacity in the image-capture apparatus. Users can use multiple removable memory device to store the taken digital images so as to expand the capacity of the memory storage in the image-capture apparatus. The other advantage of this invention is that the removable memory device can directly connect to a host so as to transmit the images of the removable memory to it by a USB connector.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a digital camera according to the prior art.

FIG. 2 is a functional block diagram of the digital camera shown in FIG. 1.

FIG. 3 is a diagram of a digital camera connected to a removable memory device according to the present invention.

FIG. 4 is a functional block diagram of the digital camera and the removable memory device shown in FIG. 3.

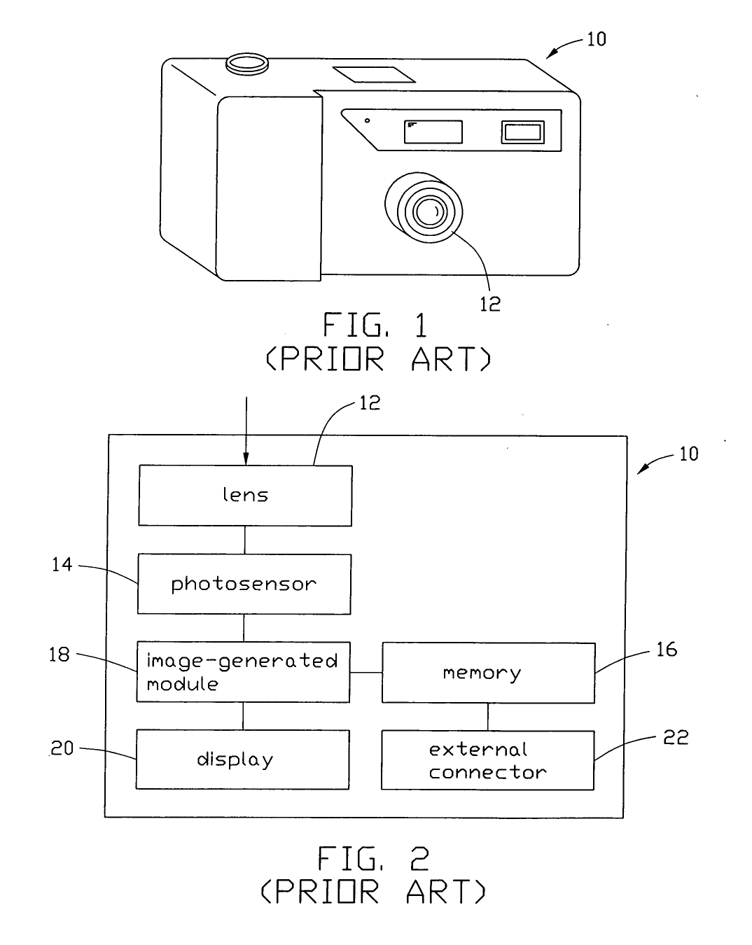

### DETAILED DESCRIPTION

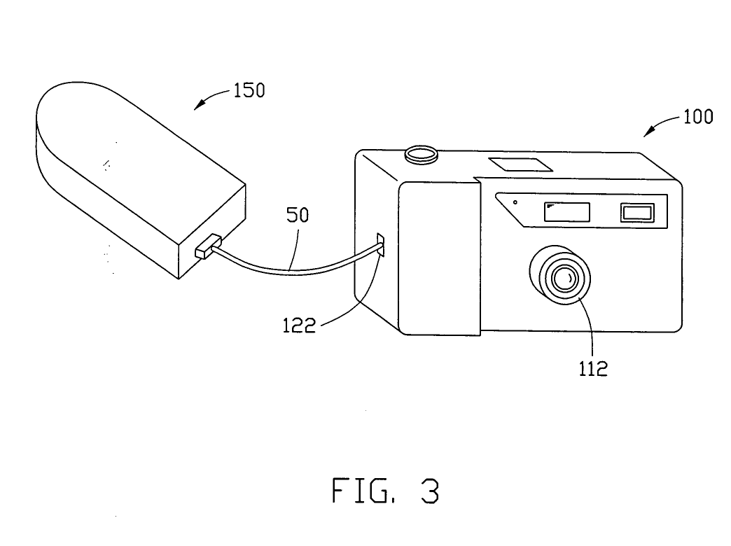

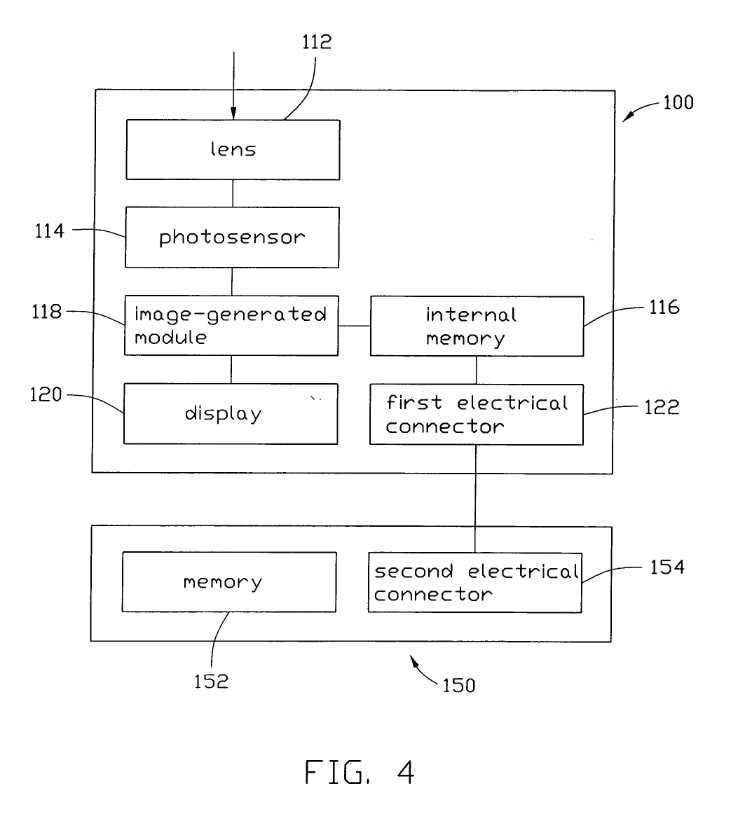

Please refer to FIG. 3 and FIG. 4. FIG. 3 is a diagram of a digital camera 100 connected to a removable memory device 150 according to the present invention. FIG. 4 is a functional block diagram of the digital camera 100 and the removable memory device 150 shown in FIG. 3. The digital camera 100 comprises a lens 112 for inputting light, a photosensor 114 for sensing the inputted light, an image-generated module 118 for generating an image based on the sensed light, a internal memory 116 for storing the generated images, and a display 120 for displaying the images. The digital camera 100 of the present invention is similar to the digital camera 10 of the prior art. However, the digital camera 100 is capable of connecting to the removable memory device 150 for increasing the memory capacity of the digital camera 100. The removable memory device 150 contains a memory 152 for storing digital images. Please note that the removable memory device 150 can be realized with a standard off-the-shelf USB portable storage device, which usually contains flash memory for the memory 152. The digital camera 100 contains a first external connector 122 for connecting to a second external connector 154 of the removable memory device 150. As shown in FIG. 3, the first external connector 122 is preferably a socket of the USB connector and the second external connector 154 is preferably a plug of the USB connector. In addition, the first electrical connector 122 can be directly connected with the second electrical connector 154, or the first electrical connector 122 is also connected with the second electrical connector 154 via a transmission line 50. Both the first electrical connector 122 and the second electrical connector 154 can be universal serial bus (USB) connectors or IEEE 1394 serial bus connectors. One or more removable memory devices 150 can be used in conjunction with the digital camera 100 for storing digital images that can be accessed through the digital camera 100. In this way, the digital camera 100 has no limit on the amount of memory that can be used to store digital images. The removable memory device 150 can be connected to a host computer for transferring digital images from the memory 152 of the removable memory device 150 to the host computer. Once the desired digital images are transferred to the host computer, the removable memory device 150 can be disconnected from the host computer. Once the removable memory device 150 is connected to the digital camera 100, the digital camera 100 treats the removable memory device 150 as a slave device, and the user interface of the digital camera 100 allows images to be selected and read from the memory 152 of the removable memory device 150 through the first external connector 122 and the second external connector 154.

When the digital camera 100 is temporarily disconnected from to the removable memory device 150, the taken images can be still stored in the internal memory 116 of the digital camera 100. The digital camera 100 contains a display 120 for indicating an operating state of the digital camera 100 to a user. For instance, the taken images stored in the memory 152 or in the memory 152 can be indicated on the display 120 along with information about the battery life of the digital camera 100.

Compared to the prior art digital camera 10, the present invention digital camera 100 is not limited to a fixed size memory capacity. A plurality of removable memory devices 150 can be used in conjunction with the digital camera 100 to provide a limitless amount of memory that can be used to store digital images. Therefore, only one digital camera 100 is needed, and the removable memory device 150 can be bought independently using off-the-shelf portable storage devices. Since there is no limit to the size of the memory that can be used to store digital images, users can always be assured of having enough capacity to take images as they wishes on long trips. In addition, both the removable memory device 150 and the image-capturing device have an USB or IEEE 1394 connector capable of communicating with a host computer with an USB or IEEE 1394 connector, so that the images stored in the removable memory device 150 can be transferred and stored into the host computer. Moreover, due to a hot plug function provided by the USB or IEEE 1394 standard, the users can plug-in or plug-out the removable memory device 150 to or from the digital camera 100 anytime and anywhere, even the digital camera 100 is being used.

Those skilled in the art will readily observe that numerous modifications and alterations of the device may be made while retaining the teachings of the invention. Accordingly, the above disclosure should be construed as limited only by the metes and bounds of the appended claims.

1. A digital camera for use in conjunction with a removable memory device, the removable memory device comprising a memory for storing digital images and a first electrical connector for transmitting the digital images to and from the memory, the digital camera comprising:
a lens for inputting light;
a photosensor for sensing the inputted light from the lens;
a image-generated module for producing digital images based on the sensed by the photosensor;
a second electrical connector separately connected with the first electrical connector of the removable memory device; and
a user interface operable to allow a user to select and to access the produced digital images stored in the memory of the removable memory device through the first and second electrical connectors.

2. The digital camera of claim 1 wherein the second electrical connector is a serial bus connector for communicating with the first electrical connector of the removable memory device serially.

3. The digital camera of claim 2 wherein the first and second electrical connectors are universal serial bus (USB) connectors.

4. The digital camera of claim 2 wherein the first and second electrical connectors are IEEE 1394 serial bus connectors.

5. The digital camera of claim 1 wherein the first electrical connector is connected with the second electrical connector via a transmission line, of which two ends are respectively compatible with the first electrical connector and the second electrical connector.

6. The digital camera of claim 1 wherein the removable memory device comprises flash memory for storing the digital images.

7. The digital camera of claim 1 wherein the removable memory device is a USB portable storage device.

8. A digital camera for use in conjunction with a universal serial bus (USB) portable storage device, the USB portable storage device comprising a memory for storing digital images and a first USB connector for transmitting the digital images to and from the memory, the digital camera comprising:
a lens for inputting light;
a photosensor for sensing the inputted light from the lens;
a image-generated module for producing digital images based on the sensed by the photosensor;
a second USB connector separately connected with the first USB connector of the USB portable storage device; and
a user interface operable to allow a user to select and to access the digital images stored in the memory of the USB portable storage device through the first and second USB connectors.

9. The digital camera of claim 8 wherein the second USB connector is a female USB connector and the first USB connector is a male USB connector.

10. The digital camera of claim 8 wherein the USB portable storage device comprises flash memory for storing the digital images.

11. The digital camera of claim 8 wherein the first electrical connector is connected with the second electrical connector via a transmission line.

12. A digital image-capturing system comprising:
a digital memory system comprising:
a non-volatile memory device storing a digital images; and
a first electrical connector formed on the digital memory system; and
an image-capturing device comprising:
a lens for inputting light;
a photosensor for sensing the inputted light from the lens;
a image-generated module for producing digital images based on the sensed by the photosensor;
a second electrical connector formed on the image-capturing device for separately connecting to the first connector; and
a user interface for allowing a user to access the digital images stored in the non-volatile memory through the first and second electrical connectors.

13. The digital image-capturing system of claim 12 wherein the second electrical connector is a serial bus connector for communicating with the first electrical connector serially.

14. The digital image-capturing system of claim 13 wherein the first and second electrical connectors are universal serial bus (USB) connectors.

15. The digital image-capturing system of claim 13 wherein the first and second electrical connectors are IEEE 1394 serial bus connectors.

16. The digital image-capturing system of claim 12 wherein the non-volatile memory device of the digital memory system is a flash memory.

17. The digital image-capturing system of claim 12 wherein the digital memory system is a USB portable storage device.

18. The digital image-capturing system of claim 12 wherein the first electrical connector is connected with the second electrical connector via a transmission line, of which two ends are respectively compatible with the first electrical connector and the second electrical connector.
